(19) United States
(12) Patent Application Publication
(10) Pub. No.: US 2013/0332928 A1
(43) Pub. Date: Dec. 12, 2013

(54) INFORMATION PROCESSING SYSTEM, INFORMATION PROCESSING METHOD, AND COMPUTER-READABLE MEDIUM

(71) Applicant: Sony Corporation, Tokyo (JP)

(72) Inventors: Hiroaki Ishizawa, Chiba (JP); Seiya Ichimori, Kanagawa (JP)

(73) Assignee: Sony Corporation, Tokyo (JP)

(21) Appl. No.: 13/899,616

(22) Filed: May 22, 2013

(30) Foreign Application Priority Data
Jun. 6, 2012 (JP) 2012-128769

(51) Int. Cl. G06F 9/44

(52) U.S. Cl. CPC G06F 9/44
USPC 718/100

(57) ABSTRACT

There is provided an information processing system including circuitry that acquires application definition information that defines a module used by an application, rewrites the application definition information depending on a circumstance of a device in which a process of the application is executed, and provides the rewritten application definition information to the device in which the process is executed.

### BACKGROUND

The present disclosure relates to an information processing system, an information processing method, and a computer-readable medium.

A process migration is a technique for continuously executing a process while changing devices which are execution subjects. In recent years, various new techniques regarding the process migration have been proposed. For example, in Masahito MUROI et al., “A Checkpoint/Restart Mechanism for Updating Server Program”, IPSJ SIG Technical Report, Aug. 3, 2010, Vol. 2010-OS-115, No. 3, a technique is disclosed in which a program bug is corrected during execution of a process in a checkpoint/restart mechanism. Here, the checkpoint/restart mechanism is a technique in which a state of a process of which execution is in progress is preserved in advance, and the execution state of the process is recovered based on the preserved information when failures occur or the like. In Shaya Potter et al., “Secure Isolation and Migration of Untrusted Legacy Applications”, Columbia University Technical Report CUCS-005-04, January, 2004, a technique for realizing a function of being capable of restricting system resources which can be accessed by an application, and a function of providing a virtualized environment for isolating an application is disclosed. The checkpoint/restart mechanism is used to migrate an application to the virtualized environment.

In addition, in Masahito MUROI et al., “A Checkpoint/Restart Mechanism for Updating Server Program”, IPSJ SIG Technical Report, Aug. 3, 2010, Vol. 2010-OS-115, No. 3, a technique is disclosed in which there is provided a replacement component set which is designed such that a device-dependent component requiring a specific hardware configuration for execution can be executed in a different hardware platform, and thereby the process migration is possible between devices with different hardware configurations. Andrey Mirkin et al., “Containers checkpointing and live migration”, Proceedings of the Linux Symposium, July, 2008, Vol. 2, p. 85 to 90 discloses virtualization of a process ID, division of a group, division and virtualization of a network, virtualization of a resource, and the like, in a technique in which a process group is migrated with the unit called a “container”.

### SUMMARY

However, it is not easy to improve a function of an application while executing a process in the process migration even using the above-described techniques. For example, in Masahito MUROI et al., “A Checkpoint/Restart Mechanism for Updating Server Program”, IPSJ SIG Technical Report, Aug. 3, 2010, Vol. 2010-OS-115, No. 3, a bug of a program of which execution is in progress can be corrected, but, for this, mounting of a process is necessary as preliminary information. In the same manner for JP 4481944B, a process migration and simultaneous function changing can be performed, but, for this, preliminary information is necessary such as information regarding whether a component is of a device-dependent type or a device-independent type, or information of a replacement component if the component is of a device-dependent type. Therefore, in the above-described techniques, it is difficult to update any application during execution.

Therefore, according to an embodiment of the present disclosure, there is provided a novel and improved information processing apparatus, information processing method and program, capable of easily improving a function of an application of which execution is in progress.

According to an embodiment of the present disclosure, there is provided an information processing system including circuitry that acquires application definition information that defines a module used by an application, rewrites the application definition information depending on a circumstance of a device in which of the application is executed, and provides the rewritten application definition information to the device in which the application is executed.

According to an embodiment of the present disclosure, there is provided an information processing method including acquiring application definition information that defines a module used by an application, rewriting the application definition information depending on a circumstance of a device in which a process of the application is executed, and providing the rewritten application definition information to the device in which the process is executed.

According to an embodiment of the present disclosure, there is provided a non-transitory computer-readable medium including a computer-program instruction, which when executed by an information processing system, cause the information processing system to acquire application definition information that defines a module used by an application, rewrite the application definition information depending on a circumstance of a device in which a process of the application is executed and provide the rewritten application definition information to the device in which the process is executed.

Application definition information is information which defines a module used by an application. This information is rewritten depending on circumstances of a device where a process of an application is executed, and thereby the process of the application can be executed using a module suitable for the circumstances of the device, and, as a result, a function of the application is improved.

As described above, according to the embodiments of the present disclosure, it is possible to easily improve a function of an application of which execution is in progress.

### BRIEF DESCRIPTION OF THE DRAWINGS

FIG. 1 is a diagram illustrating an outline of a process migration according to a first embodiment of the present disclosure;

FIG. 2 is a diagram illustrating a configuration of a process according to the first embodiment of the present disclosure;

FIG. 3 is a flowchart illustrating an example of a processing of a process migration according to the first embodiment of the present disclosure;

FIG. 4 is a block diagram illustrating a schematic functional configuration of a migration source device according to the first embodiment of the present disclosure;

FIG. 5 is a flowchart illustrating an example of a processing of a process migration according to a second embodiment of the present disclosure;

FIG. 6 is a block diagram illustrating a schematic functional configuration of a migration destination device according to the second embodiment of the present disclosure; and

FIG. 7 is a block diagram illustrating a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, the description will be made in the following order.

1. First embodiment (rewriting in migration destination device)

2. Second embodiment (rewriting in migration source device)

3. Hardware configuration

4. Conclusion

### 1. First Embodiment

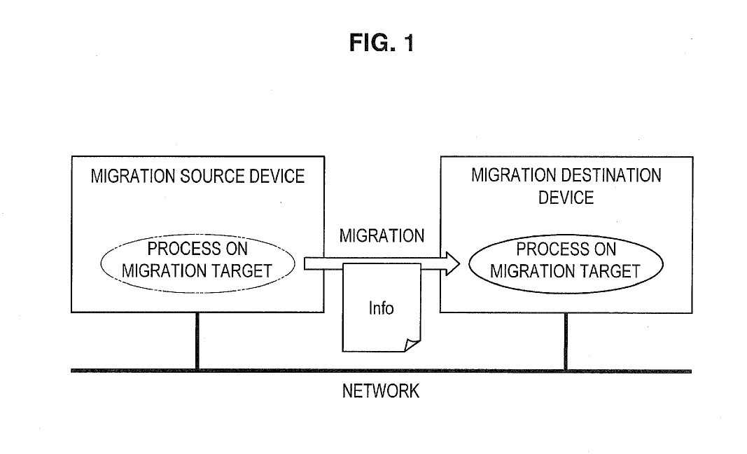

A first embodiment of the present disclosure will now be described with reference to FIGS. 1 to 4.

FIG. 1 is a diagram illustrating an outline of a process migration according to the first embodiment of the present disclosure. FIG. 1 shows an example in which a process of an application which is executed in a migration source device is continuously executed in a migration destination device.

When execution of a process which is a migration target stops in the migration source device, image information (Info) of an application is created. This image information may include application definition information which defines a module used by the application, and execution state information which indicates an execution state of the module in the process of the application. The image information is transmitted from the migration source device to the migration destination device via a network. In the migration destination device, execution of the process is resumed based on the received image information.

In the present embodiment, after the image information is transmitted to the migration destination device, the application definition information of the image information can be rewritten in the migration destination device. The migration destination device checks circumstances of the device, for example, a processing performance, a version of a module prepared as a library, a use authority for an application, and the like, and rewrites the application definition information on the basis of a result thereof.

In the migration destination device, execution of the process of the application is resumed according to the rewritten application definition information. Therefore, in the migration destination device, the application is executed using, for example, a module further adapted to a processing performance of the migration destination device, a module of a newer version, a module based on a use authority, or the like.

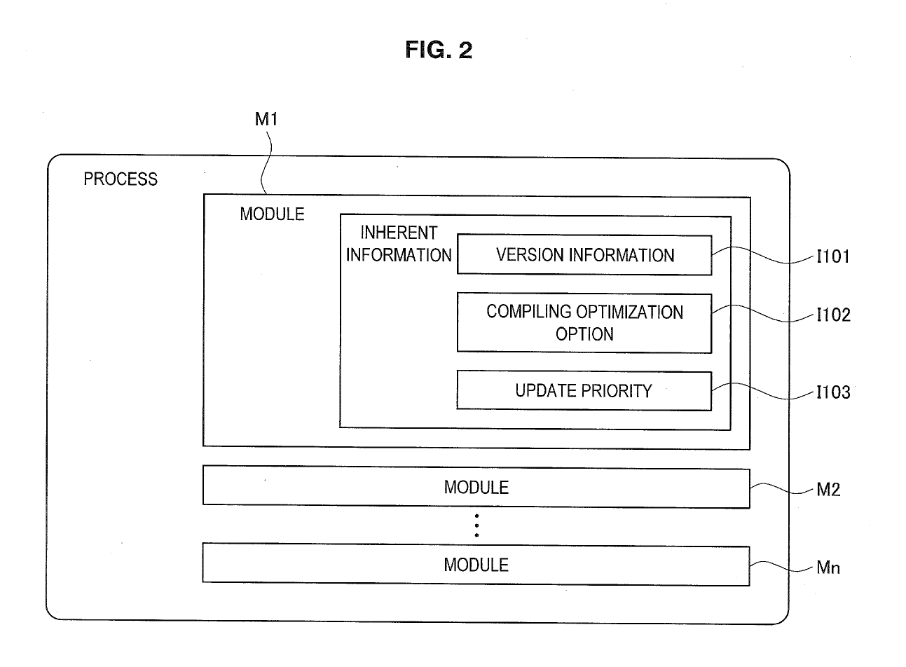

FIG. 2 is a diagram illustrating a configuration of a process according to the first embodiment of the present disclosure. The process includes one or a plurality of software modules M1, M2, . . . , Mn. When the process is executed, these modules are invoked in a predetermined order and are executed.

The application definition information defines modules used by the process of the application. Each module has inherent information. The inherent information may include, for example, as shown in FIG. 2, version information I101, compiling optimization option I102, and update priority I103.

The version information I101 is information indicating a version of a module. When a module is upgraded, a version indicated by the version information I101 is changed (for example, it is changed to a greater number). Therefore, for example, by referring to the version information I101 of modules between two devices, it is possible to determine a module of which device is newer, that is, upgraded.

The compiling optimization option I102 is information indicating a compiling optimization option (hereinafter, also simply referred to as an optimization option) which is set in a module. When the optimization option is set, a module can be executed more efficiently, and thus an operation can be performed at a high speed or resources can be saved. In addition, the optimization option is set depending on a model of each device in some cases, and, generally, that way is highly effective. For example, the optimization option is set for a specific type of CPU, and efficient execution may be realized when execution is performed using the type of CPU.

The update priority I103 is information indicating a priority to be updated in a case where a module can be updated. For example, the update priority I103 may be set in stages such as, “0: update is unnecessary”, “1: update priority is low”, and “2: update priority is high”. As described later, a module defined the application definition information is updated according to various criteria, and the update priority I103 may be used as information which directly defines an update priority.

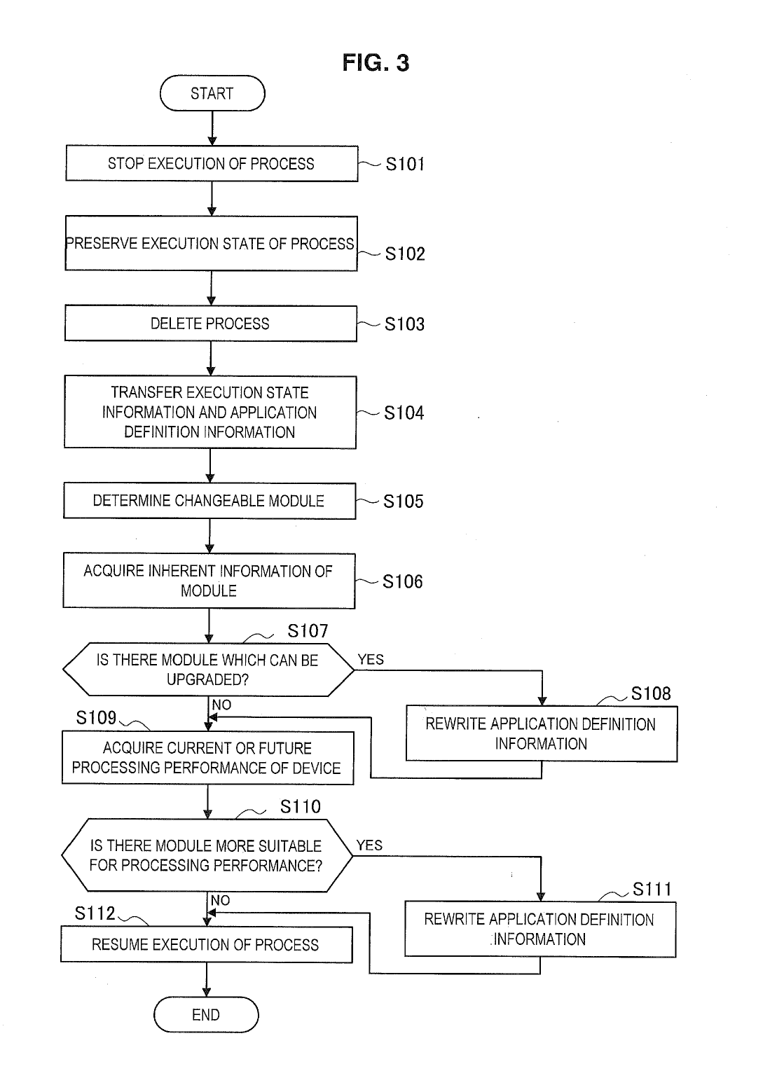

FIG. 3 is a flowchart illustrating an example of a processing of the process migration according to the first embodiment of the present disclosure.

First, in the migration source device, execution of a process of an application stops (step S101). Here, an execution state of the process is preserved (step S102). The execution state of the process is preserved as, for example, the above-mentioned image information. The image information includes application definition information and execution state information. After the execution state is preserved, the process of the application is deleted in the migration source device (step S103).

Next, the execution state information and the application definition information are transferred from the migration source device to the migration destination device (step S104). Here, the execution state information and application definition information that are transferred here are information acquired in step S102.

Successively, a processing of updating the application definition information is executed in the migration destination device. First, a module which can be changed is determined by referring to the execution state information transmitted in step S104 (step S105). The changeable module described here may be a module which has not been executed in the process before stopping, indicated by the execution state information. This is intended for preventing modules of which execution is in progress from mismatching when execution of the process is resumed in the migration destination device, in a case where a module which has been executed in the process before stopping is changed.

Next, inherent information of a module of the migration destination device is acquired (step S106). In the present embodiment, update of the application definition information is executed in the migration destination device, and thus the inherent information of a module here is acquired internally. The inherent information of a module may include, as described above, information such as version information, optimization option, and update priority. Here, a module of which inherent information is acquired may be a module which is prepared as a library in the migration destination device.

Next, it is determined whether or not there is a module which can be upgraded when execution of the process is resumed among the changeable modules determined in step S105 (step S107). Whether or not there is a module which can be upgraded can be determined, for example, based on whether or not a version indicated by the version information of a module of the migration destination device is newer than a version indicated by the version information of the module included in the application definition information. In addition, the update priority of a module of the migration destination device, or the update priority of a module included in the application definition information is referred to, and it is determined that the module can be upgraded if the update priority is high.

If there is a module which can be upgraded in step S107, the application definition information for the module is rewritten (step S108). More specifically, a definition of a module in the original application definition information is rewritten into a module of a newer version present in the migration destination device.

Next, information regarding a current processing performance of the migration destination device or a processing performance predicted in the future is acquired (step S109). The current processing performance is regarded as a processing performance when execution of the application is resumed thereafter in the migration destination device. On the other hand, the processing performance predicted in the future is regarded as a processing performance at a time when execution of the application is continued to a certain extent in the migration destination device.

Here, the “processing performance” may indicate not a static processing performance (a processing performance of a CPU, a memory capacity, and the like) on a specification but a dynamic processing performance (a use rate of a CPU, free memory space, remaining battery power, and the like). In other words, in step S108, it can be said that information indicating that the application is executed with what extent of processing performance (processing speed, available memory space, available power, and the like) is acquired when execution of the application is resumed in the migration destination device.

Next, it is determined whether or not there is a module suitable for the processing performance of the migration destination device when execution of the process is resumed from among the changeable modules determined in step S105 (step S110). For example, there is a case where, among modules, a module which is necessary for a high processing performance but realizes a sophisticated function, and a module which is necessary for a low processing performance but realizes a simple function, are selectively prepared. In this case, a module corresponding to the processing performance of the migration destination device is preferably selected. In addition, for example, by selecting a module in which compiling optimization option available to a CPU of the migration destination device is prepared, it is possible to more effectively use the processing performance of the migration destination device.

In step S110, for example, by referring to information regarding the processing performance of the migration destination device acquired in step S109 and the inherent information of the module of the migration destination device acquired in step S106, it is determined whether or not there is a module more suitable for use in execution of the application in the migration destination device. Here, if it is determined that there is a more suitable module, the application definition information for the module is rewritten (step S111). More specifically, a definition of a module in the original application definition information is rewritten into the more suitable module present in the migration destination device.

Next, execution of the process of the application is resumed using the execution state information and the rewritten application definition information in the migration destination device (step S112). A module used by the application after being resumed may be a module which is newly defined in the application definition information through the rewriting in steps S108 and S111.

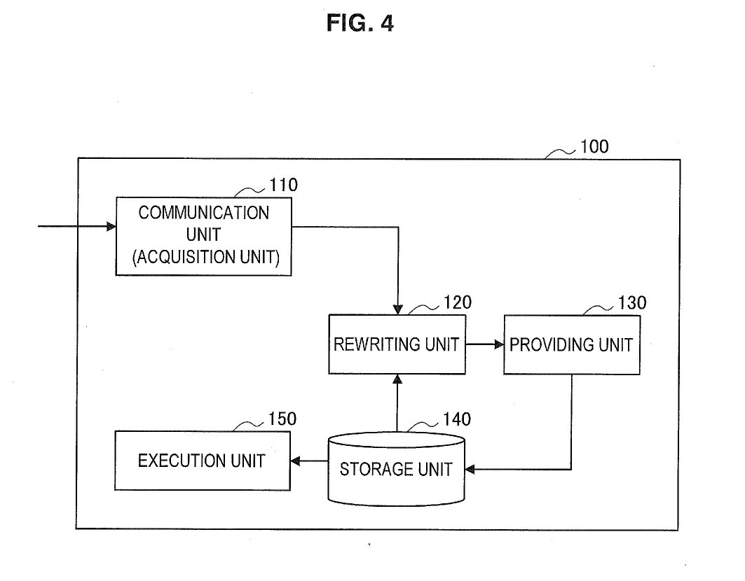

FIG. 4 is a block diagram illustrating a schematic functional configuration of the migration destination device according to the first embodiment of the present disclosure. Referring to FIG. 4, the migration destination device 100 includes a communication unit 110, a rewriting unit 120, a providing unit 130, a storage unit 140, and an execution unit 150. The migration destination device 100 may be realized by, for example, a hardware configuration of an information processing apparatus described later.

The communication unit 110 also functions as an acquisition unit which acquires application definition information from the migration source device and provides it to the rewriting unit 120 when a process migration is performed. In addition, the communication unit 110 may acquire execution state information from the migration source device and provide it to the rewriting unit 120. The communication unit 110 may be realized, for example, using a communication device or the like.

The rewriting unit 120 rewrites the application definition information acquired by the communication unit 110, depending on circumstances of a device in which a process is executed after migration, that is, the migration destination device 100. The rewriting unit 120 may rewrite the application definition information by referring to the execution state information acquired by the communication unit 110 or based on information regarding circumstances of the migration destination device 100 acquired from the storage unit 140 or the like. The rewriting unit 120 may also be realized in software, for example, by using a CPU.

For example, the rewriting unit 120 may acquire inherent information of a module of the migration destination device 100 from the storage unit 140, and may rewrite the module into an upgraded module in a case where the module defined in the application definition information is upgraded in the migration destination device 100. Through this rewriting, for example, a defect of the module can be corrected using the opportunity of the process migration.

In addition, for example, the rewriting unit 120 may acquire information regarding a current or future processing performance of the migration destination device 100 from the storage unit 140, and rewrite a module defined in the application definition information into a module suitable for the processing performance of the migration destination device 100. Here, the rewriting unit 120 may rewrite a defined module, for example, depending on an available resource amount of the migration destination device 100 (for example, in a case where a process is migrated from a mobile device in which an available resource amount is relatively small to a recorder or a game console in which an available resource amount is large, and vice versa). In addition, the rewriting unit 120 may rewrite a defined module, for example, depending on remaining battery power of the migration destination device 100 (for example, in a case where a process is migrated from an installed device connected to a power source to a mobile device, and vice versa).

Further, for example, the rewriting unit 120 may acquire information regarding a use authority for an application of the migration destination device 100 from the storage unit 140, and rewrite a module defined in the application definition information into a module suitable for the use authority of the migration destination device 100.

Through this rewriting, for example, even in an application which has a limitation of use in other devices, a process can be migrated and executed in a range in which the application can be used in the migration destination device 100.

The providing unit 130 provides the application definition information rewritten by the rewriting unit 120 to the storage unit 140. In addition, the providing unit 130 provides the execution state information acquired by the communication unit 110 to the storage unit 140 along with the application definition information. The application definition information and the execution state information may be stored in the storage unit 140 without any modification, or information stored in the storage unit 140 may be updated based on these pieces of information. The providing unit 130 may be realized in software, for example, by using a CPU.

The storage unit 140 continuously or temporarily stores a variety of information regarding execution of an application in the migration destination device 100. The storage unit 140 stores, for example, a program of a module used by an application or information indicating an execution state thereof. The application definition information or the execution state information provided by the providing unit 130 is reflected on information stored in the storage unit 140. The storage unit 140 may be realized using a variety of storage units such as RAM, ROM, a storage device, or a removable recording medium.

The execution unit 150 executes the process of the application in the migration destination device 100. The execution unit 150 invokes and executes modules, for example, according to a definition stored in the storage unit 140. At this time, the definition referred to by the execution unit 150 is a definition based on the application definition information rewritten by the rewriting unit 120. The execution unit 150 may also be realized in software, for example, by using a CPU.

In addition, a functional configuration of the migration source device may be similar to the functional configuration of the migration destination device 100. However, in the present embodiment, since the application definition information is rewritten by the migration destination device, the migration source device may not necessarily have the functional configuration of the rewriting unit 120.

### 2. Second Embodiment

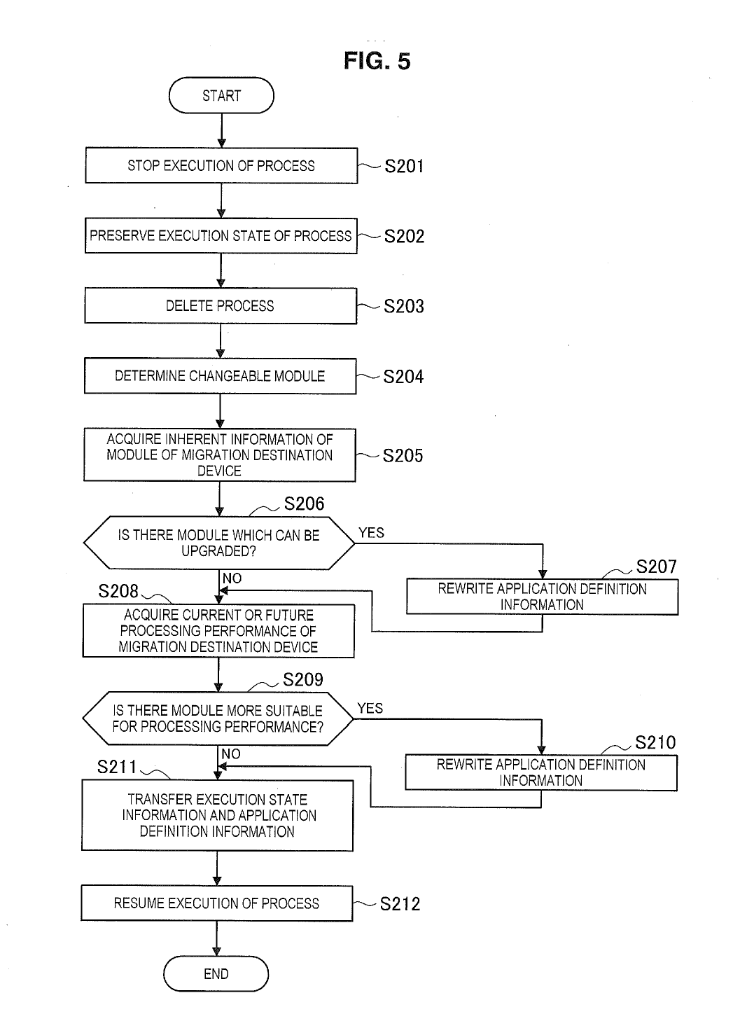

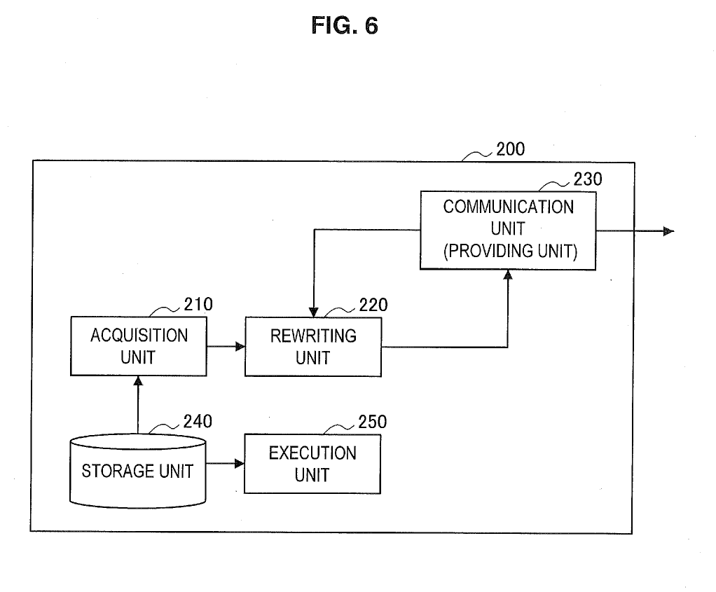

Next, the second embodiment of the present disclosure will be described with reference to FIGS. 5 and 6. In addition, an outline of the process migration and a configuration of the process are the same as those in the first embodiment, and thus detailed description thereof will be omitted.

FIG. 5 is a flowchart illustrating an example of a processing of a process migration according to the second embodiment of the present disclosure.

First, in the migration source device, execution of a process of an application stops (step S201). Here, an execution state of the process is preserved (step S202). The execution state of the process is preserved as, for example, the above-mentioned image information. The image information includes application definition information and execution state information. After the execution state is preserved, the process of the application is deleted in the migration source device (step S203).

Subsequently, a processing of updating the application definition information is executed in the migration source device. In other words, in the present embodiment, unlike in the first embodiment, the application definition information is rewritten in the migration source device, and is then transmitted to the migration destination device. First, a module which can be changed is determined by referring to the execution state information acquired in step S202 (step S204). In the same manner as in the first embodiment, the changeable module described here may be a module which has not been executed in the process before stopping, indicated by the execution state information.

Next, the migration source device has access to the migration destination device, and acquires inherent information of a module of the migration destination device (step S205). The inherent information of a module may include, as described above, information such as version information, optimization option, and update priority. Here, a module of which inherent information is acquired may be a module which is prepared as a library in the migration destination device.

Next, it is determined whether or not there is a module which can be upgraded when execution of the process of the application is resumed in the migration destination device from among the changeable modules determined in step S204 (step S206). Whether or not there is a module which can be upgraded can be determined, for example, based on whether or not a version indicated by the version information of a module of the migration destination device is newer than a version indicated by the version information of the module included in the application definition information. In addition, the update priority of a module of the migration destination device, or the update priority of a module included in the application definition information is referred to, and it may be determined that the module can be upgraded if the update priority is high.

If there is a module which can be upgraded in step S206, the application definition information for the module is rewritten (step S207). More specifically, a definition of a module in the original application definition information is rewritten into a module of a newer version present in the migration destination device.

Next, the migration source device has access to the migration destination device, and acquires information regarding a current processing performance of the migration destination device or a processing performance predicted in the future (step S208). The current processing performance is regarded as a processing performance when execution of the application is resumed thereafter in the migration destination device after the image information is transmitted to the migration destination device. On the other hand, the processing performance predicted in the future is regarded as a processing performance at a time when execution of the application is continued to a certain extent in the migration destination device.

Next, it is determined whether or not there is a module suitable for the processing performance of the migration destination device when execution of the process of the application is resumed in the migration destination device from among the changeable modules determined in step S204 (step S209). Here, for example, by referring to information regarding the processing performance of the migration destination device acquired in step S208 and the inherent information of the module of the migration destination device acquired in step S205, it is determined whether or not there is a module more suitable for use in execution of the application in the migration destination device. Here, if it is determined that there is a more suitable module, the application definition information for the module is rewritten (step S210). More specifically, a definition of a module in the original application definition information is rewritten into the more suitable module present in the migration destination device.

Next, the execution state information and the application definition information are transferred from the migration source device to the migration destination device (step S211). Here, the execution state information that is transferred here is information acquired in step S202. In addition, the application definition information being transferred here is information which is acquired in step S202 and is rewritten in steps S207 and S210 as necessary.

Next, execution of the process of the application is resumed using the execution state information and the rewritten application definition information being transferred in the migration destination device (step S212). A module used by the application after being resumed may be a module which is newly defined in the application definition information through the rewriting in steps S207 and S210.

FIG. 6 is a block diagram illustrating a schematic functional configuration of the migration source device according to the second embodiment of the present disclosure. Referring to FIG. 6, the migration source device 200 includes an acquisition unit 210, a rewriting unit 220, a communication unit 230, a storage unit 240, and an execution unit 250. The migration source device 200 may be realized by, for example, a hardware configuration of an information processing apparatus described later.

The acquisition unit 210 acquires application definition information when a process migration is performed and provides the acquired application definition information to the rewriting unit 220. In addition, the acquisition unit 210 may acquire execution state information and provide it to the rewriting unit 220. The application definition information and the execution state information may be acquired from the storage unit 240, or may be generated by the acquisition unit 210 based on information stored in the storage unit 240. The acquisition unit 210 may be realized in software, for example, by using a CPU.

When a process migration is performed, the rewriting unit 220 rewrites the application definition information acquired by the acquisition unit 210 depending on circumstances of a device in which a process is to be executed after migration, that is, the migration destination device 100. The rewriting unit 220 may rewrite the application definition information by referring to the execution state information acquired by the acquisition unit 210 or based on information regarding circumstances of the migration destination device acquired via the communication unit 230. The rewriting unit 220 may also be realized in software, for example, by using a CPU. In addition, a specific example of the rewriting performed by the rewriting unit 220 may be the same as in the first embodiment.

The communication unit 230 functions as a providing unit which provides the application definition information rewritten by the rewriting unit 220 to a device in which the process after being migrated is executed, that is, the migration destination device. In addition, the communication unit 230 provides the execution state information acquired by the acquisition unit 210 along with the application definition information. The communication unit 230 may receive information regarding circumstances of the migration destination device and provide it to the rewriting unit 220. The communication unit 230 may be realized, for example, using a communication device or the like.

The storage unit 240 continuously or temporarily stores a variety of information regarding execution of an application in the migration source device 200. The storage unit 240 stores, for example, a program of a module used by an application or information indicating an execution state thereof. The application definition information or the execution state information generated when the process of the application is migrated may be generated based on information stored in the storage unit 240. The storage unit 240 may be realized using a variety of storage units such as RAM, ROM, a storage device, or a removable recording medium.

The execution unit 250 executes the process of the application in the migration source device 200. The execution unit 250 invokes and executes modules, for example, according to a definition stored in the storage unit 240. At this time, the execution unit 250 records an execution state of the modules in the storage unit 240. The execution unit 250 may also be realized in software, for example, by using a CPU.

In addition, a functional configuration of the migration destination device may be similar to the functional configuration of the migration source device 200 described above. However, in the present embodiment, since the application definition information is rewritten by the migration source device, the migration destination device may not necessarily have the functional configuration of the rewriting unit 220.

### 3. Hardware Configuration

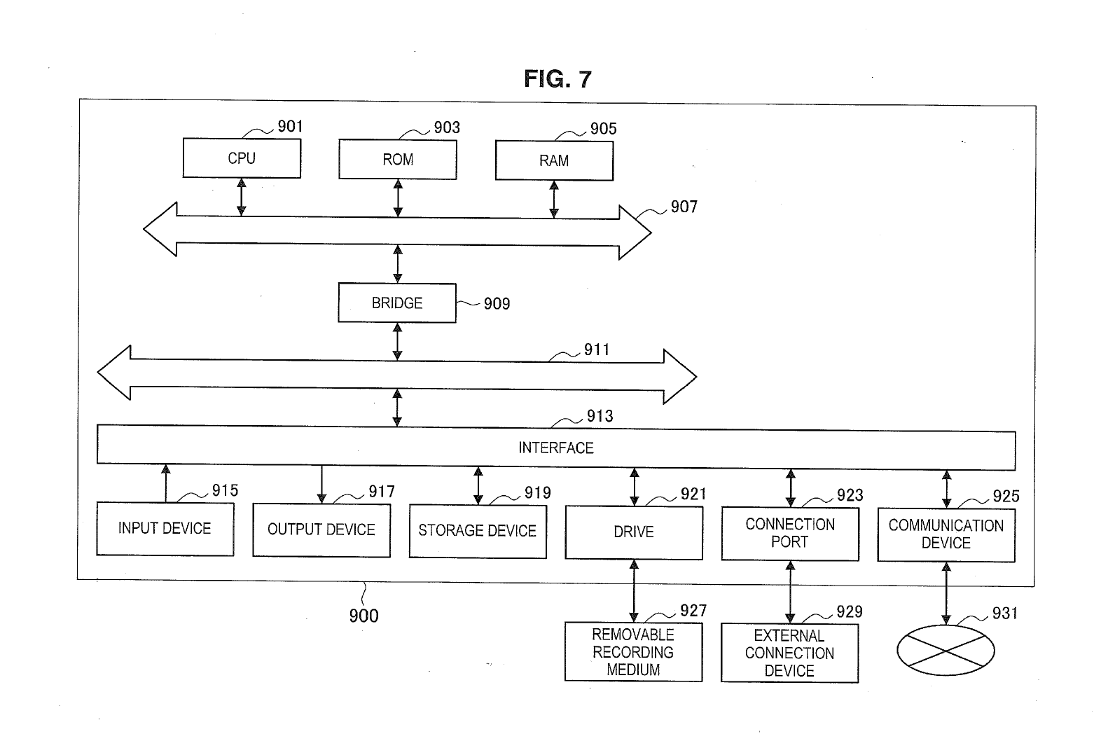

Next, with reference to FIG. 7, a description will be made of a hardware configuration of an information processing apparatus according to an embodiment of the present disclosure. FIG. 7 is a block diagram illustrating a hardware configuration of the information processing apparatus. The shown information processing apparatus 900 may realize, for example, the migration destination device 100, the migration source device 200, and the like in the above-described embodiments.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input device 915, an output device 917, a storage device 919, a drive 921, a connection port 923, and a communication device 925. The information processing apparatus 900 may include a processing circuit such as a DSP (Digital Signal Processor), alternatively or in addition to the CPU 901.

The CPU 901 serves as an operation processor and a controller, and controls all or some operations in the information processing apparatus 900 in accordance with various programs recorded in the ROM 903, the RAM 905, the storage device 919 or a removable recording medium 927. The ROM 903 stores programs and operation parameters which are used by the CPU 901. The RAM 905 primarily stores program which are used in the execution of the CPU 901 and parameters which is appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input device 915 may be a device which is operated by a user, such as a mouse, a keyboard, a touch panel, buttons, switches and a lever. The input device 915 may be, for example, a remote control unit using infrared light or other radio waves, or may be an external connection device 929 such as a portable phone operable in response to the operation of the information processing apparatus 900. Furthermore, the input device 915 includes an input control circuit which generates an input signal on the basis of the information which is input by a user and outputs the input signal to the CPU 901. By operating the input device 915, a user can input various types of data to the information processing apparatus 900 or issue instructions for causing the information processing apparatus 900 to perform a processing operation.

The output device 917 includes a device capable of visually or audibly notifying the user of acquired information. The output device 917 may include a display device such as LCD (Liquid Crystal Display), PDP (Plasma Display Panel), and organic EL (Electro-Luminescence) displays, an audio output device such as speaker and headphone, and a peripheral device such as printer. The output device 917 may output the results obtained from the process of the information processing apparatus 900 in a form of a video such as text or image, and an audio such as voice or sound.

The storage device 919 is a device for data storage which is configured as an example of a storage unit of the information processing apparatus 900. The storage device 919 includes, for example, a magnetic storage device such as HDD (Hard Disk Drive), a semiconductor storage device, an optical storage device, or a magneto-optical storage device. The storage device 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 can write in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection device 929 to the connection port 923 makes it possible to exchange various data between the information processing apparatus 900 and the external connection device 929.

The communication device 925 is, for example, a communication interface including a communication device or the like for connection to a communication network 931. The communication device 925 may be, for example, a communication card for a wired or wireless LAN (Local Area Network), Bluetooth (registered trademark), WUSB (Wireless USB) or the like. In addition, the communication device 925 may be a router for optical communication, a router for ADSL (Asymmetric Digital Subscriber Line), a modem for various kinds of communications, or the like. The communication device 925 can transmit and receive signals to and from, for example, the Internet or other communication devices based on a predetermined protocol such as TCP/IP. In addition, the communication network 931 connected to the communication device 925 may be a network or the like connected in a wired or wireless manner, and may be, for example, the Internet, a home LAN, infrared communication, radio wave communication, satellite communication, or the like.

As above, the exemplary hardware configuration of the information processing apparatus 900 has been described. Each of the above-described constituent elements may be configured using general-purpose members, or may be configured by hardware specialized to the function of each constituent element. Therefore, a hardware configuration to be used may be appropriately modified according to the technical level at the time of implementing the embodiment.

### 4. Conclusion

In the above-described embodiments of the present disclosure, the application definition information is rewritten when the process migration is performed, and a module used in the process of the application is updated. As in the above-described embodiments, the application definition information may be rewritten in the migration destination device or may be rewritten in the migration source device. Alternatively, the application definition information may be temporarily sent to a server different from the migration source device and the migration destination device and be rewritten there.

When the process migration is performed, since it is expected by a user that a processing originally stops for a while, the above-mentioned updating of a module is executed using the time, and thereby it is possible to shorten time necessary for the updating which the user feels as compared with a case where the module is updated during normal execution.

In addition, since rewriting of the application definition information targets a module which has not been executed in a process, the process can be continuously executed without variation after a process migration and module update are completed. A module which has been executed in a process is not updated, but a process migration is expected to be performed not once but several times, and thus the module may be updated at other opportunities of the process migration.

In rewriting of the application definition information, whether or not the rewriting is performed for each module by referring to information such as, for example, version information, compiling optimization option, and update priority, and thus preliminary information regarding application mounting or the like is not necessary. Therefore, the application definition information can be rewritten for any application which is a target of a process migration.

In addition, although, in the above-described embodiments, a description has been made of an example in which the application definition information is rewritten when a process migration is performed, an embodiment of the present disclosure is also applicable to a case where a process migration is not necessarily performed. For example, in a case where circumstances of a device, such as, for example, processing speed of a CPU, available memory space, or available power vary due to influence of another process when a process of a certain application is executed, the application definition information may be rewritten depending on the circumstances, and the process of the application may be continuously executed in the same device using the rewritten application definition information.

(Example of Effects)

Hereinafter, a specific example of effects achieved by the embodiments of the present disclosure will be described.

For example, in a case where it is found that free memory space of the migration destination device is small, the application definition information is rewritten so as to use a library of a version with smaller memory usage. Therefore, it is possible to smoothly execute an application after a process migration is performed as well. On the other hand, in a case where it is found that free memory space of the migration destination device is large, the application definition information may be rewritten so as to use a library of a version which has large memory usage but can represent sophisticated images and audio at a high processing speed.

In addition, for example, in a case where it is found that a processing performance of a CPU of the migration destination device is high, the application definition information may be rewritten so as to use a library of a version which has complex processing but can represent sophisticated images and audio at high processing speed. Therefore, it is possible to enjoy image and audio representation which completely utilizes the processing performance of the CPU of the migration destination device after a process migration is performed. On the other hand, in a case where it is found that a processing performance of the CPU of the migration destination device is low, the application definition information may be rewritten so as to use a library of a version which has simple processing and can represent unsophisticated images and audio.

In addition, for example, in a case where it is found that a remaining battery power of the migration destination device is small, the application definition information is rewritten so as to use a library of a version which puts a small burden on the CPU or other devices. Therefore, the remaining battery time of the migration destination device is not extremely shortened after a process migration is performed as well. On the other hand, in a case where remaining battery power of the migration destination device is large or the migration destination device is connected to a power source, the application definition information may be rewritten so as to use a library of a version which uses the CPU or other devices.

Further, for example, in a case where a process of a moving image player is migrated, the application definition information is rewritten so as to link a library of a newer version when the migration is performed, and thereby the moving image player after being migrated corresponds to a new codec. The moving image player itself is migrated in a state of continuously reproducing moving images, and thus a user feels as if moving image formats which can be reproduced by the moving image player increase during that time.

In addition, for example, in a case where a process of an application is migrated, the application definition information is rewritten so as to link a library of a version which handles vulnerability found recently, and thereby it is possible to handle the vulnerability in a state of continuously executing the application.

In addition, for example, it is also possible to distribute a function-limited edition of a game being played in a certain device to a friend. In this case, image information of an application of the game is generated, and a module defined in application definition information included in the image information is rewritten into a module with a time limit (for example, a half hour time limit) or a module in which an image or audio output is limited. In this case, a process is not stopped and migrated in the migration source device, but the image information is transmitted to the migration destination device in a state of continuously executing the process in the migration source device, and the process is executed in both of the migration source device and the migration destination device. If the distribution of a function-limited edition becomes possible, it is considered that a case where the distribution itself is allowed increases, and, as a result, convenience of users is improved.

As an addition configuration, when there is a library which is not compatible with a library of the migration destination device from among libraries used by an application, the library may be copied along with a process migration. In addition, in a process migration, a device which prepares for a library compatible with a library used by an application may be selected as a migration destination device. In a case where there is no such device, the library may be copied (or migrated) along with the process migration. The compatibility of a file (shared library) used by an application with that of a migration destination device may be checked before a process of the application stops in a migration source device, or may be checked after the process stops.

The embodiments of the present disclosure, as described above, may include the information processing apparatus, information processing system, information processing method, program for causing a computer to function as the information processing apparatus, and recording medium which records therein the program.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing system including:

circuitry configured to
acquire application definition information that defines a module used by an application;
rewrite the application definition information depending on a circumstance of a device in which a process of the application is executed; and
provide the rewritten application definition information to the device in which the process is executed.
   (2) The information processing system according to (1),
wherein the application definition information is transmitted and received between the information processing apparatus and an external device according to a change in a subject executing the process, and
wherein the circuitry rewrites the application definition information depending on a circumstance of a migration destination device which becomes a new subject executing the process of the information processing apparatus or the external device.
   (3) The information processing system according to (2), wherein the circuitry rewrites the module defined by the application definition information into a module suitable for a processing performance of the migration destination device in performing the transmission and/or reception or a processing performance predicted after performing the transmission and/or reception.
   (4) The information processing system according to (3), wherein the circuitry rewrites the module defined by the application definition information depending on an available resource amount of the migration destination device.
   (5) The information processing system according to (3) or (4), wherein the circuitry rewrites the module defined by the application definition information depending on remaining battery power of the migration destination device.
   (6) The information processing system according to (2) to (5), wherein, when the module defined by the application definition information is upgraded in the migration destination device, the circuitry rewrites the module into the upgraded module.
   (7) The information processing system according to (2) to (6), wherein the circuitry rewrites the module defined by the application definition information into a module suitable for a use authority included in the migration destination device.
   (8) The information processing system according to (2) to (7),
wherein the circuitry receives the application definition information from the external device, rewrites the application definition information depending on a circumstance of the information processing apparatus, and internally provides the rewritten application definition information.
   (9) The information processing system according to (2) to (7),
wherein the circuitry internally acquires the application definition information, and receives information indicating a circumstance of the external device from the external device, rewrites the application definition information depending on the circumstance of the external device, and transmits the rewritten application definition information to the external device.
   (10) The information processing system according to (1) to (9),
wherein the circuitry further acquires execution state information indicating an execution state of the module in the process of the application, and
wherein the execution state information indicates that the module has not been executed, and the circuitry rewrites the application definition information with respect to the module.
   (11) The information processing system according to (1) to (10), wherein the circuitry rewrites the module defined by the application definition information into a module suitable for a processing performance of the device in which the process of the application is executed.
   (12) An information processing method including:
acquiring application definition information that defines a module used by an application;
rewriting the application definition information depending on a circumstance of a device in which a process of the application is executed; and
providing the rewritten application definition information to the device in which the process is executed.
   (13) A non-transitory computer-readable medium including a computer-program instruction, which when executed by an information processing system, cause the information processing system to:
acquire application definition information that defines a module used by an application;
rewrite the application definition information depending on a circumstance of a device in which a process of the application is executed; and
provide the rewritten application definition information to the device in which the process is executed.

The present disclosure contains subject matter related to that disclosed in Japanese Priority Patent Application JP 2012-128769 filed in the Japan Patent Office on Jun. 6, 2012, the entire content of which is hereby incorporated by reference.

What is claimed is:

1. An information processing system comprising:
circuitry configured to
acquire application definition information that defines a module used by an application;
rewrite the application definition information depending on a circumstance of a device in which a process of the application is executed; and
provide the rewritten application definition information to the device in which the process is executed.

2. The information processing system according to claim 1,
wherein the application definition information is transmitted and received between the information processing apparatus and an external device according to a change in a subject executing the process, and
wherein the circuitry rewrites the application definition information depending on a circumstance of a migration destination device which becomes a new subject executing the process of the information processing apparatus or the external device.

3. The information processing system according to claim 2, wherein the circuitry rewrites the module defined by the application definition information into a module suitable for a processing performance of the migration destination device in performing the transmission and/or reception or a processing performance predicted after performing the transmission and/or reception.

4. The information processing system according to claim 3, wherein the circuitry rewrites the module defined by the application definition information depending on an available resource amount of the migration destination device.

5. The information processing system according to claim 3, wherein the circuitry rewrites the module defined by the application definition information depending on remaining battery power of the migration destination device.

6. The information processing system according to claim 2, wherein, when the module defined by the application definition information is upgraded in the migration destination device, the circuitry rewrites the module into the upgraded module.

7. The information processing system according to claim 2, wherein the circuitry rewrites the module defined by the application definition information into a module suitable for a use authority included in the migration destination device.

8. The information processing system according to claim 2,
wherein the circuitry receives the application definition information from the external device, rewrites the application definition information depending on a circumstance of the information processing apparatus, and internally provides the rewritten application definition information.

9. The information processing system according to claim 2,
wherein the circuitry internally acquires the application definition information, and receives information indicating a circumstance of the external device from the external device, rewrites the application definition information depending on the circumstance of the external device, and transmits the rewritten application definition information to the external device.

10. The information processing system according to claim 1,
wherein the circuitry further acquires execution state information indicating an execution state of the module in the process of the application, and
wherein the execution state information indicates that the module has not been executed, and the circuitry rewrites the application definition information with respect to the module.

11. The information processing system according to claim 1, wherein the circuitry rewrites the module defined by the application definition information into a module suitable for a processing performance of the device in which the process of the application is executed.

12. An information processing method comprising:
acquiring application definition information that defines a module used by an application;
rewriting the application definition information depending on a circumstance of a device in which a process of the application is executed; and
providing the rewritten application definition information to the device in which the process is executed.

13. A non-transitory computer-readable medium including a computer-program instruction, which when executed by an information processing system, cause the information processing system to:
acquire application definition information that defines a module used by an application;
rewrite the application definition information depending on a circumstance of a device in which a process of the application is executed; and
provide the rewritten application definition information to the device in which the process is executed.
